(19) United States
(12) Patent Application Publication
(10) Pub. No.: US 2023/0386736 A1
(43) Pub. Date: Nov. 30, 2023

(54) COIL COMPONENT

(71) Applicant: SAMSUNG ELECTRO-MECHANICS CO., LTD., Suwon-si (KR)

(72) Inventors: Boum Seock Kim, Suwon-si (KR); Byeong Cheol Moon, Suwon-si (KR); Sang Jin Kim, Suwon-si (KR); Han Lee, Suwon-si (KR); Hyo Yong Sim, Suwon-si (KR)

(73) Assignee: SAMSUNG ELECTRO-MECHANICS CO., LTD., Suwon-si (KR)

(21) Appl. No.: 18/110,013

(22) Filed: Feb. 15, 2023

(30) Foreign Application Priority Data
May 30, 2022 (KR) 10-2022-0065839

(51) Int. Cl. H01F 27/32; H01F 27/30; H01F 27/29; H01F 27/02

(52) U.S. Cl. CPC H01F 27/323; H01F 27/306; H01F 27/292; H01F 27/022

(57) ABSTRACT

A coil component includes a body including a first surface and a second surface opposing each other in a first direction, a coil portion disposed in the body and including first and second coils, and a via connecting the first and second coils to each other, an insulating film covering the coil portion and extending to a region between the first and second coils, and first and second external electrodes disposed on the body and connected to the coil portion. The insulating film is in contact with at least one of opposing surfaces of the first and second coils which face each other and is in contact with a side surface of the via.

### CROSS-REFERENCE TO RELATED APPLICATION(S)

This application claims the benefit of priority to Korean Patent Application No. 10-2022-0065839 filed on May 30, 2022 in the Korean Intellectual Property Office, the disclosure of which is incorporated herein by reference in its entirety.

### BACKGROUND

### 1. Technical Field

The present disclosure relates to a coil component.

### 2. Description of Related Art

An inductor, a coil component, is a passive electronic component used in electronic devices along with a resistor and a capacitor.

As electronic devices have been designed to have high-performance and a reduced size, the number of electronic components used in electronic devices has been increased and sizes thereof have been reduced.

Meanwhile, in the case of a thin film-type inductor in which a non-magnetic substrate is embedded in a component, an effective volume may be reduced by an amount equal to the volume occupied by the substrate in the component.

### SUMMARY

An aspect of the present disclosure is to provide a coil component which may have improved inductance properties by increasing an effective volume by an amount equal to a volume occupied by a substrate supporting a coil portion in a thin film inductor by completely removing the substrate.

Another aspect of the present disclosure is to provide a coil component in which possible defects which may occur during a mechanical processing process for a substrate may be reduced.

According to an aspect of the present disclosure, a coil component includes a body including a first surface and a second surface opposing each other in a first direction, a coil portion disposed in the body and including first and second coils, and a via connecting the first and second coils to each other, an insulating film covering the coil portion and extending to a region between the first and second coils, and first and second external electrodes disposed on the body and connected to the coil portion. The insulating film is in contact with at least one of opposing surfaces of the first and second coils which face each other and is in contact with a side surface of the via.

According to another aspect of the present disclosure, a coil component includes a body including a first surface and a second surface opposing each other in a first direction; a coil portion disposed in the body and including first and second coils, and a via connecting the first and second coils to each other; a first insulating film covering an upper surface, a lower surface and a side surface of the first coil; a second insulating film covering an upper surface, a lower surface and aside surface of the second coil; and first and second external electrodes disposed on the body and connected to the first and second coils, respectively. Each of the first and second insulating films extends along a side surface of the via.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective diagram illustrating a coil component according to a first embodiment of the present disclosure;

FIG. 2 is a cross-sectional diagram taken along line I-I′ in FIG. 1 and an enlarged diagram illustrating region A1;

FIG. 3 is a cross-sectional diagram taken along line II-II′ in FIG. 1 and an enlarged diagram illustrating region B1;

FIG. 4 is a cross-sectional diagram illustrating a coil component taken along line I-I′ according to a second embodiment and an enlarged diagram illustrating region A2, corresponding to FIG. 2;

FIG. 5 is a cross-sectional diagram illustrating a coil component taken along line II-II′ according to a second embodiment and an enlarged diagram illustrating region B2, corresponding to FIG. 3;

FIG. 6 is a cross-sectional diagram illustrating a coil component taken along line II-II′ according to a third embodiment and an enlarged diagram illustrating region B3, corresponding to FIG. 5;

FIG. 7 is a cross-sectional diagram illustrating a coil component taken along line II-II′ according to a fourth embodiment and an enlarged diagram illustrating region B4, corresponding to FIG. 6; and

FIGS. 8, 9 and 10 are diagrams illustrating a method of manufacturing a coil component according to a first embodiment of the present disclosure.

### DETAILED DESCRIPTION

The terms used in the embodiments are used to simply describe an embodiment, and are not intended to limit the present disclosure. A singular term includes a plural form unless otherwise indicated. The terms, “include,” “comprise,” “is configured to,” and the like, of the description are used to indicate the presence of features, numbers, steps, operations, elements, portions or combination thereof, and do not exclude the possibilities of combination or addition of one or more features, numbers, steps, operations, elements, portions or combination thereof. Also, the term. “disposed on,” “disposed on,” and the like, may indicate that an element is disposed on or beneath an object, and may not necessarily mean that the element is disposed on the object with reference to a gravity direction.

The term. “coupled to,” “combined to,” and the like, may not only indicate that elements are directly and physically in contact with each other, but also include the configuration in which the other element is interposed between the elements such that the elements are also in contact with the other component.

The size and thickness of each component in the drawings may be arbitrarily indicated for ease of description, and thus, the present disclosure is not necessarily limited to the illustrated examples.

In the drawings, an L direction is a first direction or a length direction, a W direction is a second direction or a width direction, a T direction is a third direction or a thickness direction.

Hereinafter, a coil component according to an embodiment will be described in detail with reference to the accompanying drawings, and in the description with reference to the accompanying drawings, the same or corresponding components may be provided with the same reference numerals and overlapping description thereof will not be provided.

In electronic devices, various types of electronic components may be used, and various types of coil components may be used between the electronic components to remove noise, or for other purposes.

In other words, in electronic devices, a coil component may be used as a power inductor, a high frequency inductor (HF inductor), a general bead, a high frequency bead (GHz bead), a common mode filter, and the like.

### First Embodiment

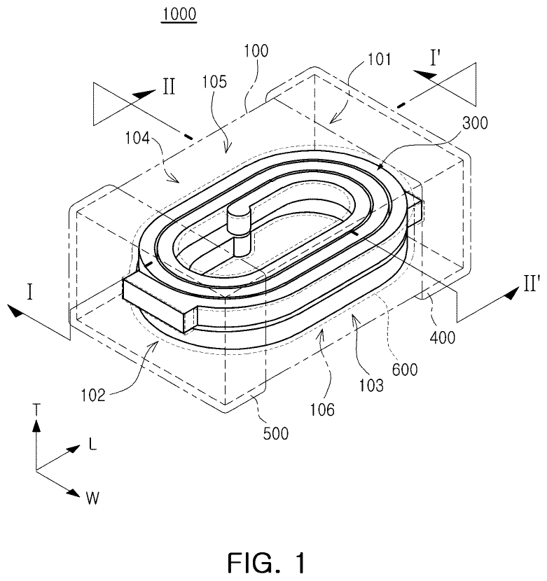

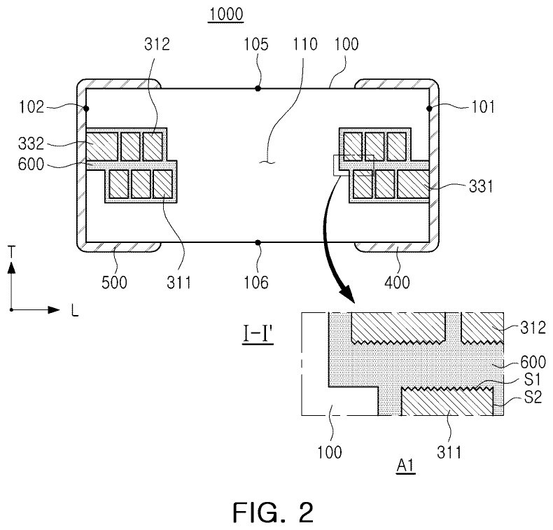

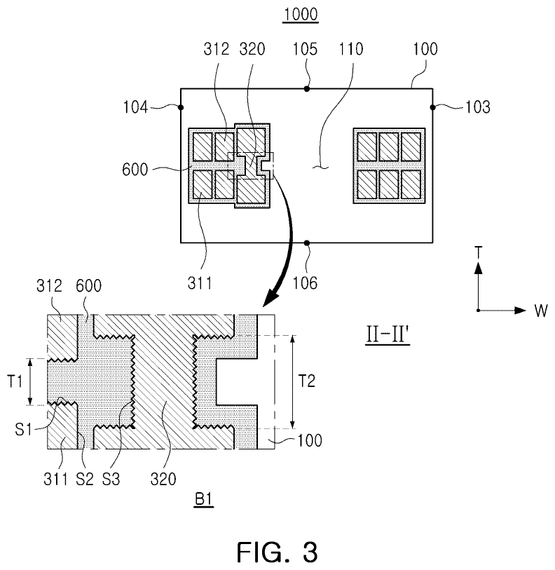

FIG. 1 is a perspective diagram illustrating a coil component according to a first embodiment. FIG. 2 is a cross-sectional diagram taken along line I-I′ in FIG. 1 and an enlarged diagram illustrating region A1. FIG. 3 is a cross-sectional diagram taken along line II-II′ in FIG. 1 and an enlarged diagram illustrating region B1.

To more clearly illustrate the coupling between the components, the external insulating layer disposed on the body 100 applied to the embodiment is not illustrated.

Referring to FIGS. 1 to 3, the coil component 1000 according to the first embodiment may include a body 100, a coil 300, first and second external electrodes 400 and 500, and an insulating film 600.

A general thin film type inductor may have a substrate supporting a coil portion in a body, and in the coil component 1000 according to the embodiment the coil portion 300 may be formed using a metal substrate 200 and the metal substrate 200 may be removed, such that the substrate may not remain in the coil component 1000.

The body 100 may form an exterior of the coil component 1000 in the embodiment, and the coil portion 300 and the insulating film 600 may be disposed in the body 100.

The body 100 may have a hexahedral shape.

The body 100 may include a first surface 101 and a second surface 102 opposing each other in the first direction (the length direction L), a third surface 103 and a fourth surface 104 opposing each other in the second direction (in the width direction W), and a fifth surface 105 and a sixth surface 106 opposing each other in the third direction (in the thickness direction T), with respect to the directions in FIG. 1. Each of the first to fourth surfaces 101, 102, 103 and 104 of the body 100 may be a wall surface of the body 100 connecting the fifth surface 105 to the sixth surface 106 of the body 100. Hereinafter, both end surfaces (one end surface and the other end surface) of the body 100 may refer to the first surface 101 and the second surface 102 of the body 100, both side surfaces (one side surface and the other side surface) of the body 100 may refer to the third surface 103 and the fourth surface 104 of the body 100, and one surface and the other surface of the body 100 may refer to the sixth surface 106 and the fifth surface 105 of the body 100.

The body 100 may be formed such that the coil component in which the external electrodes 400 and 500 are formed may have a length of 2.5 mm, a width of 2.0 mm and a thickness of 1.0 mm, may have a length of 2.0 mm, a width of 1.2 mm and a thickness of 1.0 mm, may have a length of 2.0 mm, a width of 1.2 mm and a thickness of 0.65 mm, may a length of 1.6 mm, a width of 0.8 mm and a thickness of 0.8 mm, may have a length of 1.0 mm, a width of 0.5 mm and a thickness of 0.5 mm, or may have a length of 0.8 mm, a width of 0.4 mm and a thickness of 0.65 mm, but an example embodiment thereof is not limited thereto. Since the above-described numerical value examples for the length, width, and thickness of the coil component 1000 do not reflect process errors, and a numerical value in a range recognized as a process error may correspond to the above-described numerical value examples.

The length of the above-described coil component 1000 may be a maximum value among dimensions of a plurality of line segments connecting two outermost boundary lines of the coil component 1000, opposing each other in the length direction L, to each other and in parallel to the length direction L, with respect to an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments connecting two outermost boundary lines of the coil component 1000, opposing each other in the length direction L, to each other and in parallel to the length direction L. Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an example embodiment thereof is not limited thereto.

The thickness of the above-described coil component 1000 be a maximum value among dimensions of a plurality of line segments connecting two outermost boundary lines of the coil component 1000, opposing each other in the thickness direction T, to each other and in parallel to the thickness direction T, with respect to an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments connecting two outermost boundary lines of the coil component 1000, opposing each other in the length direction T, to each other and in parallel to the length direction T. Alternatively, the length of the coil component 1000 may refer to an arithmetic mean value of at least three or more of the dimensions of the plurality of line segments described above. Here, the plurality of line segments parallel to the thickness direction T may be spaced apart from each other by an equal distance in the thickness direction T, but an example embodiment thereof is not limited thereto.

The width of the above-described coil component 1000 may be a maximum value among dimensions of a plurality of line segments connecting two outermost boundary lines of the coil component 1000, opposing each other in the width direction W, to each other and in parallel to the width direction W, with respect to an optical microscope image or a scanning electron microscope (SEM) image with respect to a cross-section in the length direction L-width direction W taken from the central portion of the coil component 1000 taken in the thickness direction T. Alternatively, the width of the coil component 1000 may refer to a minimum value among the dimensions of the plurality of line segments connecting two outermost boundary lines of the coil component 1000, opposing each other in the width direction W, to each other and in parallel to the width direction W. Alternatively, the width of the coil component 1000 may refer to an arithmetic mean value of at least three or more of the dimensions of the plurality of line segments connecting two outermost boundary lines of the coil component 1000, opposing each other in the width direction W, to each other and in parallel to the width direction W. Here, the plurality of line segments parallel to the width direction W may be spaced apart from each other by an equal distance in the thickness direction T, but an example embodiment thereof is not limited thereto.

Alternatively, each of the length, width and thickness of the coil component 1000 may be measured by a micrometer measurement method. The micrometer measurement method may be of determining a zero point with a gauge repeatability and reproducibility (R&R) micrometer, inserting the coil component 1000 in the embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000.

The body 100 may include an insulating resin and a magnetic material. Specifically, the body 100 may be formed by laminating one or more magnetic composite sheets in which a magnetic material is dispersed in an insulating resin. The magnetic material may be ferrite or a magnetic metal powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an example embodiment thereof is not limited thereto.

Each particle of ferrite and magnetic metal powder may have an average diameter of about 0.1 μm to 30 μm, but an example embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape.

In the description below, the magnetic material may be a magnetic metal powder, but an example embodiment thereof is not limited to the body 100 having a structure in which magnetic metal powder is dispersed in an insulating resin.

The insulating resin may include epoxy, polyimide, a liquid crystal polymer, or the like, alone or in combination but an example embodiment thereof is not limited thereto.

Referring to FIGS. 2 and 3, the body 100 may include a core 110 penetrating the winding center region of the coil portion 300 to be described later. The core 110 may be formed by filling the through-hole 110h formed in the winding center region of the coil portion 300 with a magnetic composite sheet including a magnetic material, but an example embodiment thereof is not limited thereto.

The coil portion 300 may be disposed inside the body 100 and may exhibit the characteristics of the coil component 1000. For example, when the coil component 1000 of the embodiment is used as a power inductor, the coil portion 300 may maintain an output voltage by storing an electric field as a magnetic field, thereby stabilizing the power of the electronic device.

The coil component 1000 according to the embodiment may include the coil portion 300 covered by the insulating film 600 inside the body 100. The coil portion 300 may form a turn around the core 110.

Referring to FIGS. 1 to 3, the coil portion 300 may include first and second coils 311 and 312, and vias 320, and may further include first and second lead-out portions 331 and 332. Specifically, with respect to the direction in FIG. 1, the first coil 311 and the first lead-out portion 331 may be disposed to face the sixth surface 106 of the body 100, and the second coil 312 and the second lead-out portion 332 may be disposed to face the fifth surfaces 105.

In the coil portion 300 of the embodiment, the region other than the region in which the first and second lead-out portions 331 and 332 are exposed to the first and second surfaces 101 and 102, respectively, may be covered by an insulating film 600 to be described later.

Referring to FIGS. 1 to 3, each of the first coil 311 and the second coil 312 may have at least one turn about the core 110 as an axis. Each of the first coil 311 and the second coil 312 may have a planar spiral shape.

The first and second coils 311 and 312 may be covered by an insulating film 600 to be described later, and the insulating film 600 may also be disposed in a spaced region between the first and second coils 311 and 312.

Referring to FIG. 3, the coil portion 300 may include a via 320 connecting the first and second coils 311 and 312 to each other in the insulating film 600.

The via 320 may electrically connect the first and second coils 311 and 312 to each other in the insulating film 600. Specifically, with respect to the direction in FIG. 1, the lower surface of the via 320 may be connected to the end of the innermost turn of the first coil 311, and the upper surface of the via 320 may be connected to the end of the innermost turn of the second coil 312.

Referring to FIGS. 1 and 2, the coil portion 300 may include first and second lead-out portions 331 and 332 exposed to the first and second surfaces 101 and 102 of the body 100, respectively.

The first lead-out portion 331 may be connected to the first coil 311, may be exposed to the first surface 101 of the body 100, and may be connected to the first external electrode 400 to be described later. Also, the second lead-out portion 332 may be connected to the second coil 312, may be exposed to the second surface 102 of the body 100, and may be connected to a second external electrode 500 to be described later. That is, the input from the first external electrode 400 may pass through the first lead-out portion 331, the first coil 311, the via 320, the second coil 312, and the second lead-out portion 332 in sequence and may be output through the second external electrode 500.

Accordingly, the coil portion 300 may function as a single coil between the first and second external electrodes 400 and 500.

At least one of the first and second coils 311 and 312, the via 320, and the first and second lead-out portions 331 and 332 may include at least one conductive layer.

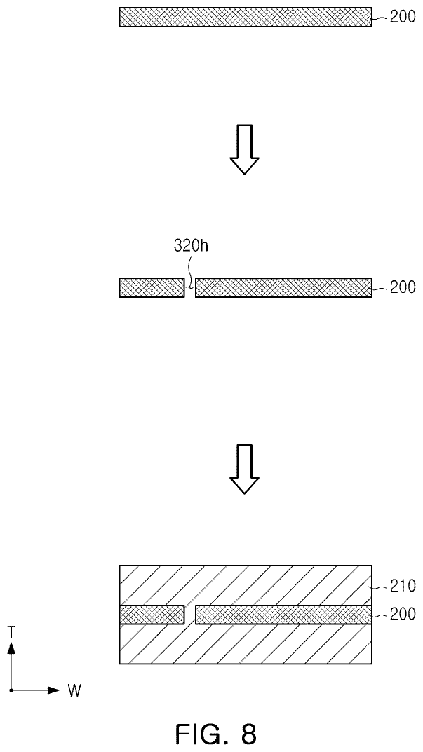

Meanwhile, in the case of the coil component 1000 according to the embodiment, the first and second coils 311 and 312, the via 320, and the first and second lead-out portions 331 and 332 may be formed without a seed layer. Since the metal substrate 200 (see FIGS. 8 to 10) is used during the process of plating the coil portion 300, the process of forming a seed layer may not be performed.

As an example, referring to FIGS. 3, 4, and 8 to 10, when the first coil 311, the via 320, and the first lead-out portion 331 are formed on one surface of the metal substrate 200 by plating, each of the first coil 311, the via 320, and the first lead-out portion 331 may include an electrolytic plating layer. Here, the electroplating layer may have a single-layer structure or a multiple layer structure. The electrolytic plating layer having a multilayer structure may be formed in a conformal film structure in which an electroplating layer is formed along the surface of the other electroplating layer, or an electroplating layer may be laminated only on one surface of the other electroplating layer.

The first coil 311, the first via 320, and the electrolytic plating layer of each of the first lead-out portion 331 may be integrally formed such that a boundary may not be formed therebetween, but an example embodiment thereof is not limited thereto.

Each of the first coil 311, the first via 320, and the first lead-out portion 331 may be formed of a conductive material such as copper (Cu), aluminum (Al), silver (Ag), tin (Sn), gold (Au), nickel (Ni), lead (Pb), titanium (Ti), chromium (Cr), or alloys thereof, but an example embodiment thereof is not limited thereto.

Referring to FIGS. 2 and 3, the coil component 1000 according to the embodiment may include an insulating film 600 covering the coil portion 300 and extending to a region between the first and second coils 311 and 312. The insulating film 600 may be disposed to be in contact with the surface on which the first and second coils 311 and 312 oppose each other and a side surface of the via 320. Here, the surface on which the first and second coils 311 and 312 oppose each other and the side surface of the vias 320 may be formed without a seed layer and may be in direct contact with the insulating film 600.

Specifically, the insulating film 600 may be disposed between the coil portion 300 and the body 100, and the insulating film 600 may be conformally formed along the surfaces of the first and second coils 311 and 312, the vias 320, and the first and second lead-out portions 331 and 332, but an example embodiment thereof is not limited thereto.

However, the surfaces on which the first and second lead-out portions 331 and 332 are in contact with the first and second external electrodes 400 and 500, respectively, may not be covered by the insulating film 600.

Referring to FIGS. 2 and 3, the insulating film 600 may insulate the coil turns from each other by filling the regions between the turns of the first and second coils 311 and 312 adjacent to each other, and the regions between the first and second lead-out portions 331 and 332 and the first and second coils 311 and 312. Also, the insulating film 600 may insulate the surfaces on which the first and second coils 311 and 312 oppose each other from each other.

The insulating film 600 may be provided to insulate the coil portion 300 and the body 100, and may include a well-known insulating material such as paraline, but an example embodiment thereof is not limited thereto. As another example, the insulating film 600 may include an insulating material such as an epoxy resin other than paraline. The insulating film 600 may be formed by vapor deposition, but an example embodiment thereof is not limited thereto. As another example, the insulating film 600 may be formed by laminating and curing an insulating film, or may be formed by applying and curing an insulating paste.

The coil component 1000 according to the embodiment may not include a substrate supporting the coil portion 300 therein. Specifically, the coil portion 300 may be formed on the metal substrate 200 and the metal substrate 200 may be removed by a chemical method such as wet etching. Accordingly, the coil component 1000 according to the embodiment may not include a substrate component therein, and in the process of removing the metal substrate 200, surface roughness of the coil portion 300 may vary for each region.

Here, the surface roughness may refer to an arithmetical average roughness Ra, and may refer to the average value of the roughness measured on the surfaces of the first and second coils 311 and 312 or the via 320. The average roughness Ra of the first and second coils 311 and 312 or the via 320 may be measured by measuring the depth of the unevenness formed on the surface of the first and second coils 311 and 312 or the via 320 and calculating each arithmetic mean value of these measured values. For example, the average roughness Ra may be an arithmetic mean of values measured at three points spaced apart from each other by an equal distance in the L direction or the T direction, but an example embodiment thereof is not limited thereto.

Surface roughness may be measured using a micro-profiler, which is a 3D measuring instrument which may measure roughness and surface shape, and for example, an optical surface profiler such as a 7300 optical surface profiler of Zygo Corporation, or a surface roughness meter SV-3200 of Mitutoyo may be used, but an example embodiment thereof is not limited thereto. The surface roughness disclosed herein may be measured by a standard method that will be apparent to and understood by one of ordinary skill in the art.

Referring to FIG. 2, surface roughness of the surface S1 on which the first and second coils 311 and 312 oppose each other, that is, the upper surface of the first coil 311 and the lower surface of the second coil 311 with respect to the direction in FIG. 2, may be different from the surface roughness of the side surfaces S2 of the first and second coils 311 and 312. For example, the surface roughness of the surface S1 on which the first and second coils 311 and 312 oppose each other may be greater than the surface roughness of the side surface S2 of the first and second coils 311 and 312.

Also, surface roughness of the surface on which the first coil 311 opposes the sixth surface 106 of the body 100 and the surface on which the second coil 312 opposes the fifth surface 105 of the body 100 may be configured to be different from the surface roughness of the surface S1 on which the first and second coils 311 and 312 oppose each other, that is, the upper surface of the first coil 311 and the lower surface of the second coil 312.

The above-described difference in surface roughness may be due to the manufacturing process, and the surface S1 on which the first and second coils 311 and 312 oppose each other may be the region from which the metal substrate 200 is removed, and the side surface S2 of the first and second coils 311 and 312 may be the region from which the barrier wall 210 (see FIGS. 8 to 10) working as a plating guide is removed, and the surface on which the first coil 311 opposes the sixth surface of the body 100 and the surface on which the second coil 312 opposes the fifth surface 105 of the body 100 may not undergo an etching process, such that surface roughness may be formed different in the regions.

Referring to FIG. 3, the surface roughness of the surface connecting the side surface S3 of the via 320, that is, the surface on which the via 320 and the first and second coils 311 and 312 are in contact with each other, may be different from the surface roughness of the side surface S2 of the coils 311 and 312. For example, the surface roughness of the side surface S3 of the via 320 may be greater than the surface roughness of the side surface S2 of the first and second coils 311 and 312.

The above-described difference in surface roughness may be due to the manufacturing process, and the side surface S3 of the via 320 may be a region from which the metal substrate 200 is removed, and the side surface S2 of the first and second coils 311 and 312 may be a region from which the barrier wall 210 (see FIGS. 8 to 10) working as a plating guide is removed, and accordingly, the surface roughness may be formed differently in the regions.

Meanwhile, surface roughness of the surface S1 on which the first and second coils 311 and 312 oppose each other, that is, the upper surface of the first coil 311 and the lower surface of the second coil 312 may be substantially the same as the surface roughness of the side surface S3 of the via 320. In this case, the configuration in which the surface roughness may be substantially the same may include process errors or positional deviations occurring during the manufacturing process, and errors during measurement.

Referring to FIG. 3, the spacing T1 between the first and second coils in the region between the first and second coils 311 and 312 in which the insulating film 600 is disposed may be smaller than the spacing T2 between the first and second coils 311 and 312 in the region in which the second coils 311 and 312 are in contact with the via 320.

As described above, when the spacing T1 between the first and second coils in the region between the first and second coils 311 and 312 in which the insulating film 600 is disposed is configured to be relatively small, the volume of the body 100 disposed on and below the coil portion 300 may increase, and accordingly, the flow of magnetic flux becomes smoother such that inductance properties of the coil component 1000 may improve.

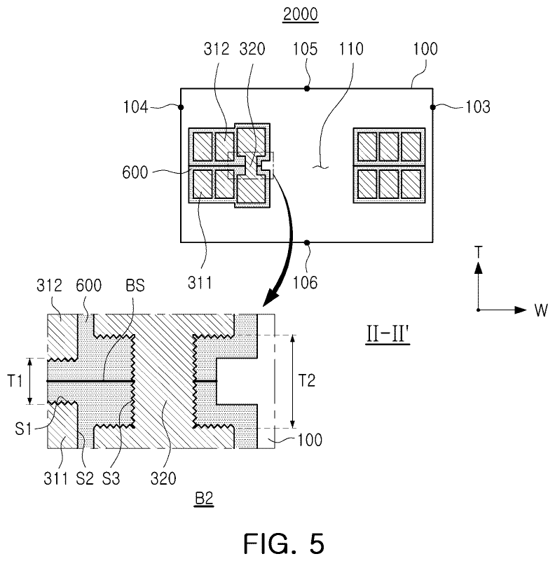

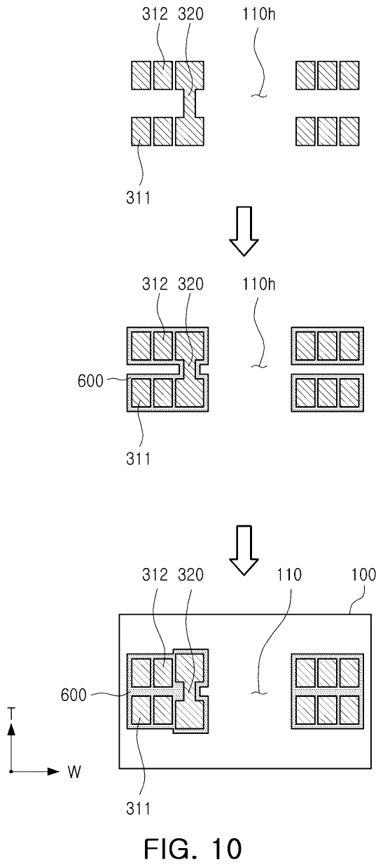

Such a structure may be formed through a process of disposing the insulating film 600 and compressing the insulating film 600 in the thickness direction (T direction) which will be described in greater detail later with reference to FIG. 10. As a result, an overall thickness of a portion of the coil portion 300 including the via 320 may be greater than an overall thickness of another portion of the coil portion 300 not including the via 320 (FIGS. 3 and 5).

Here, the spacing between the first and second coils 311 and 312 may refer to an arithmetic mean value of at least three or more of the dimensions of a plurality of line segments connecting two outermost boundary lines of the first and second coil components 1000, opposing each other in the thickness direction T, to each other and in parallel to the thickness direction T, with respect to an optical microscope image or a scanning electron microscope (SEM) image with respect to a cross-section in the width direction W-thickness direction T taken from the central portion of the coil component 1000 taken in the length direction L. Here, the plurality of line segments parallel to the thickness direction T may be spaced apart from each other by an equal distance in the width direction W, but an example embodiment thereof is not limited thereto.

Referring to FIGS. 2 and 3, the insulating film 600 disposed between the first and second coils 311 and 312 may be integrally formed. Here, the configuration of being integrally formed may indicate that the boundary surface may not be formed in the insulating film 600 covering the surfaces of the first and second coils 311 and 312 opposing each other. The insulating film 600 disposed between the first and second coils 311 and 312 may be integrated depending on conditions such as temperature and pressure during the compression process by heating and pressure, but an example embodiment thereof is not limited thereto.

The external electrodes 400 and 500 may be spaced apart from each other on the body 100 and may be connected to the coil 300. Specifically, the first external electrode 400 may be disposed on the first surface 101 of the body 100 and may be in contact with and connected to the first lead-out portion 331 extending to the first surface 101 of the body 100. The second external electrode 500 may be disposed on the second surface 102 of the body 100 and may be in contact with and connected to the second lead-out portion 332 extending to the second surface 102 of the body 100.

Referring to FIGS. 1 and 2, the first external electrode 400 may be disposed on the first surface 101 of the body 100 and may extend to at least a portion of the third to sixth surfaces 103, 104, 105, and 106. The second external electrode 500 may be disposed on the second surface 102 of the body 100 and may extend to at least a portion of the third to sixth surfaces 103, 104, 105, and 106 of the body 100.

The first and second external electrodes 400 and 500 may have various shapes, and the first and second external electrodes 400 and 500 may be disposed on the first surface 101 and the second surface 102 of the body 100, respectively, and may only extend to the sixth surface 106 of the body 100.

In this case, the first external electrode 400 may include a first pad portion disposed on the first surface 101 of the body 100, and a first extension portion connecting the first lead-out portion 331 to the first pad portion.

Also, the second external electrode 500 may include a second pad portion spaced apart from the first pad portion on the sixth surface 106 of the body 100, and a second extension portion disposed on the second surface 102 of the body 100 and connecting the second lead-out portion 332 to the second pad portion.

The pad portion and the extension portion may be formed together in the same process and may be integrally formed without forming a boundary therebetween, but an example embodiment thereof is not limited thereto.

The external electrodes 400 and 500 may be formed by a vapor deposition method such as sputtering and/or a plating method, but an example embodiment thereof is not limited thereto.

The external electrodes 400 and 500 may be formed of a conductive material such as copper (Cu), aluminum (Al), silver (Ag), tin (Sn), gold (Au), nickel (Ni), lead (Pb), chromium (Cr), titanium (Ti), or alloys thereof, but an example embodiment thereof is not limited thereto.

The external electrodes 400 and 500 may be formed in a single-layer structure or multiple-layer structure. For example, the external electrodes 400 and 500 may include a first conductive layer including copper (Cu), a second conductive layer disposed on the first conductive layer and including nickel (Ni), and a third conductive layer disposed on the second conductive layer and including tin (Sn). At least one of the second conductive layer and the third conductive layer may be formed to cover the first conductive layer, but an example embodiment thereof is not limited thereto. The first conductive layer may be a plating layer or a conductive resin layer formed by coating and curing a conductive resin including conductive powder including at least one of copper (Cu) and silver (Ag) and a resin. The second and third conductive layers may be plating layers, but an example embodiment thereof is not limited thereto.

The coil component 1000 according to the embodiment may further include an external insulating layer disposed on the third to sixth surfaces 103, 104, 105, and 106 of the body 100. The external insulating layer may be disposed on a region other than the region in which the external electrodes 400 and 500 are disposed among the surfaces of the body 100.

At least a portion of the external insulating layers disposed on each of the third to sixth surfaces 103, 104, 105, and 106 of the body 100 may be formed in the same process, such that the external insulating layers may be integrated with each other without a boundary therebetween, but an example embodiment thereof is not limited thereto.

The external insulating layer may be formed by forming an insulating material for forming an external insulating layer by a method such as a printing method, a vapor deposition method, a spray application method, a film lamination method, or the like, but an example embodiment thereof is not limited thereto.

The external insulating layer may include a thermoplastic resin such as polystyrene resin, vinyl acetate resin, polyester resin, polyethylene resin, polypropylene resin, polyamide resin, rubber resin, acrylic resin, a thermosetting resin such that phenol resin, epoxy resin, urethane resin, melamine resin, alkyd resin, a photosensitive resin, parallen, SiOₓ or SiNₓ. The external insulating layer may further include an insulating filler such as an inorganic filler, but an example embodiment thereof is not limited thereto.

### Second to Fourth Embodiments

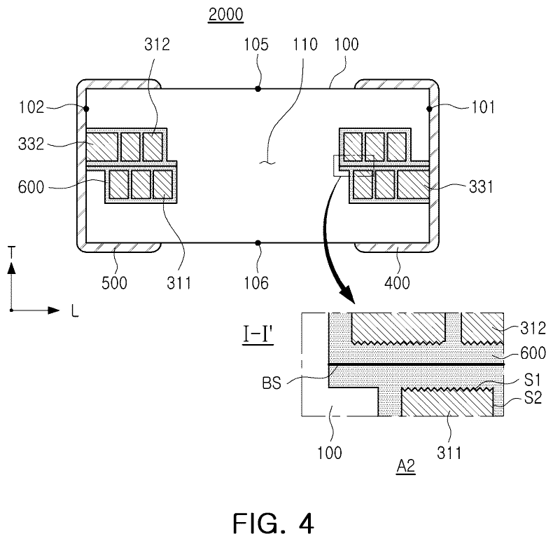

FIG. 4 is a cross-sectional diagram illustrating a coil component taken along line I-I′ according to a second embodiment and an enlarged diagram illustrating region A2, corresponding to FIG. 2. FIG. 5 is a cross-sectional diagram illustrating a coil component taken along line II-II′ according to a second embodiment and an enlarged diagram illustrating region B2, corresponding to FIG. 3.

Referring to FIGS. 4 and 5, the coil component 2000 according to the second embodiment, the configuration in which a boundary surface BS is formed on the insulating film 600 between the first and second coils 311 and 312 may be different from the first embodiment.

Therefore, in describing the embodiment, only the insulating film 600 disposed between the first and second coils 311 and 312 different from the first embodiment will be described. For the rest of the elements of the embodiment, the description described with reference to the first embodiment may be applied.

Referring to FIGS. 4 and 5, the insulating film 600 disposed between the first and second coils 311 and 312 may have a boundary surface BS substantially parallel to the first direction (length direction), which may be a structure which may be formed depending on conditions such as temperature and pressure in the compression process of the coil portion 300 covered by the insulating film 600. In this case, the configuration of being “substantially parallel” may include process errors or positional deviations occurring during the manufacturing process, and errors during measurement.

In the coil component 2000 of the embodiment, the insulating film 600 disposed between the first and second coils 311 and 312 may not be completely integrated, and a boundary surface BS may be formed, and the boundary surface BS may be a gap formed at a predetermined distance, but an example embodiment thereof is not limited thereto.

The spacing between the first coil 311 and the boundary surface BS may be substantially the same as the spacing between the second coil 312 and the boundary surface BS. In this case, the configuration of being “substantially the same” may include process errors or positional deviations occurring during the manufacturing process, and errors during measurement.

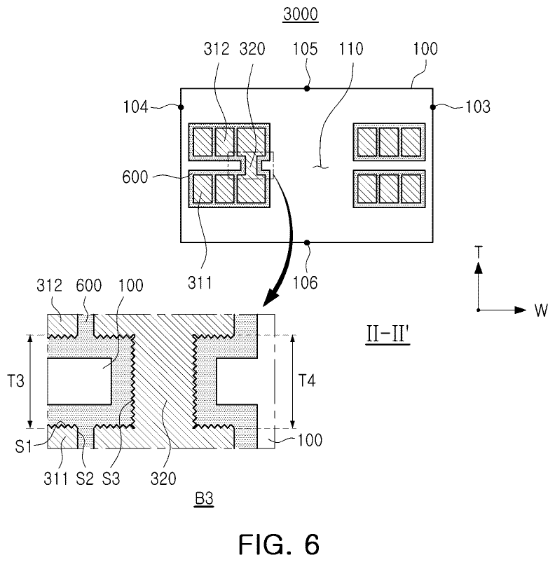

FIG. 6 is a cross-sectional diagram illustrating a coil component taken along line II-II′ according to a third embodiment and an enlarged diagram illustrating region B3, corresponding to FIG. 5.

Referring to FIG. 6, in the coil component 3000 according to the third embodiment, the configuration in which a material forming the body 100 may be filled in a spacing between the insulating film 600 on the first coil 311 and the insulating film 600 on the second coil 312 may be different from the second embodiment.

Therefore, in describing the embodiment, the insulating film 600 structure between the first and second coils 311 and 312, and the relationship between the spacing T3 between the first and second coils 311 and 312 and the thickness T4 of the via 320 will be described, which may be different from the second embodiment. For the rest of the elements of the embodiment, the description described with reference to the second embodiment may be applied.

Referring to FIG. 6, the insulating film 600 of the embodiment may cover the first and second coils 311 and 312 in the region between the first and second coils 311 and 312, respectively, and with reference to the direction in FIG. 6, the insulating film 600 covering the upper surface of the first coil 311 may be spaced apart from the insulating film 600 covering the lower surface of the second coil 312.

Meanwhile, the spacing may be filled with a material forming the body 100, such as, for example, an insulating resin and/or a magnetic material may be disposed in the spacing. Here, the magnetic material may be ferrite or a magnetic metal powder.

In the embodiment, since the compression process may not be performed after forming the insulating film 600 on the coil portion 300, deformation of the coil portion 300, particularly the via 320, may be prevented.

Meanwhile, referring to FIG. 6, as the compression process is not performed, the spacing between the first and second coils 311 and 312 may be uniformly formed in each turn. For example, the spacing T3 between the first and second coils in the region between the first and second coils 311 and 312 in which the insulating film 600 is disposed may be formed to be substantially equal to the spacing T4 between the first and second coils 311 and 312 in a region in which the first and second coils 311 and 312 are in contact with the via 320. In this case, the configuration in which the spacings are substantially equal may include process errors or positional deviations occurring during the manufacturing process, and errors during measurement.

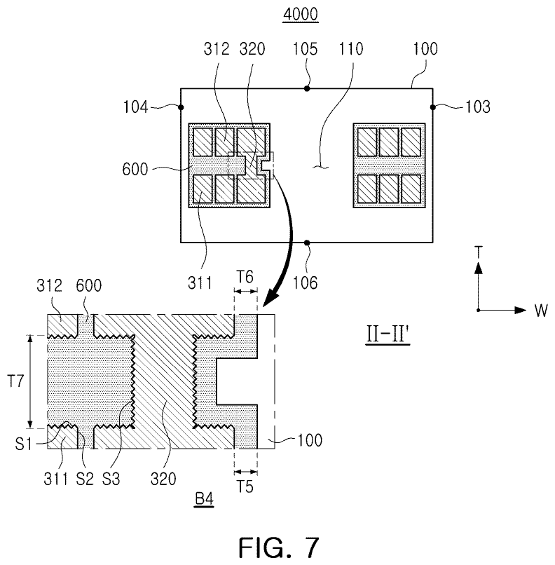

FIG. 7 is a cross-sectional diagram illustrating a coil component taken along line II-II′ according to a fourth embodiment and an enlarged diagram illustrating region B4, corresponding to FIG. 6.

Referring to FIG. 7, in the coil component 4000 according to the fourth embodiment, the structure of the insulating film 600 disposed between the first and second coils 311 and 312 may be different, and the relationship between the thicknesses T5 and T6 of the insulating film 600 disposed on the first and second coils 311 and 312 and the thickness T7 of the insulating film 600 between the first and second coils 311 and 312 may be different, as compared to the third embodiment.

Therefore, in describing the embodiment, mainly the structure of the insulating film 600 disposed between the first and second coils 311 and 312 different from the third embodiment, and the relationship between the thicknesses T5 and T6 of the insulating film 600 disposed on the patterns 311 and 312 and the thickness T7 of the insulating film 600 between the first and second coils 311 and 312 will be described. For the rest of the elements of the embodiment, the description described with reference to the third embodiment may be applied.

Referring to FIG. 7, the insulating film 600 disposed between the first and second coils 311 and 312 may be integrally formed, and a spacing between the first and second coils 311 and 312 may be configured to be greater than the sum of the thickness T5 of the insulating film 600 covering the innermost turn of the first coil 311 and the thickness T6 of the insulating film 600 covering the innermost turn of the second coil 312.

That is, the thickness T7 of the insulating film 600 disposed between the first and second coils 311 and 312 may be greater than the sum of the thickness T5 of the insulating film 600 covering the innermost turn of the first coil 311 and the thickness T6 of the insulating film 600 covering the innermost turn of the second coil 312.

In all of the embodiments disclosed herein, the dimensions such as T1, T2, . . . , T7 may be measured by a standard method that will be apparent to and understood by one of ordinary skill in the art.

In the embodiment, the compression process may not be performed, and since the insulating film 600 between the first and second coils 311 and 312 is configured to have a thickness greater than those of other embodiments, the coil portion 300 deformation may be further prevented.

(Method of Manufacturing Coil Component)

FIGS. 8 to 10 are diagrams illustrating a method of manufacturing a coil component 1000 according to a first embodiment. Meanwhile, the same process as the present manufacturing method may be applied to the coil component s 2000, 3000, and 4000 according to the second to fourth embodiments, and only the last two processes in FIG. 10 may be varied.

Referring to FIG. 8, first, a metal substrate 200 may be prepared. Generally, in the case of a copper clad laminate (CCL) substrate commonly used in a thin-film inductor, the substrate may remain in the coil component and may thus occupy a predetermined volume, whereas, in the embodiment, the metal substrate 200 may be removed by etching after the coil portion 300 is formed, such that an effective volume may be ensured by an amount equal to the removed region.

Therefore, as a material of the metal substrate 200, iron (Fe), nickel (Ni), which has stronger metallic properties than copper (Cu) forming the coil portion 300, such that selective etching with sulfuric acid (S) may be performed, or alloys thereof, such as, for example, Invar alloy steel (INVAR, FeNi36) may be used. However, it may be preferable not to use aluminum (Al), chromium (Cr), or alloys thereof which may form a passivation film when reacting with acid as the material of the metal substrate 200.

Thereafter, a via hole 320h, which is a space in which the via 320 is to be filled, may be formed in the metal substrate 200. The via hole 320h may be formed using a mechanical drill and/or a laser drill. For example, a CO2 laser, a YAG laser, a UV laser, a green laser, or the like, may be used, and the via hole 320h of a desired size may be formed by appropriately adjusting laser intensity, but an example embodiment thereof is not limited thereto.

Thereafter, the barrier walls 210 may be formed on both side surfaces of the metal substrate 200. The barrier wall 210 may be a resist film, and may be formed by a method of laminating and curing a resist film or a method of applying and curing a resist film material, but an example embodiment thereof is not limited thereto. As a lamination method, for example, a method of performing hot pressing in which pressure is applied at a high temperature for a predetermined period of time, drying in a cold press, and separating a work tool may be used. As a coating method, for example, a screen-printing method of applying ink with a squeegee, or a spray printing method of misting and applying ink may be used. The curing may be drying to not be completely cured so as to use a photolithography method as a subsequent process.

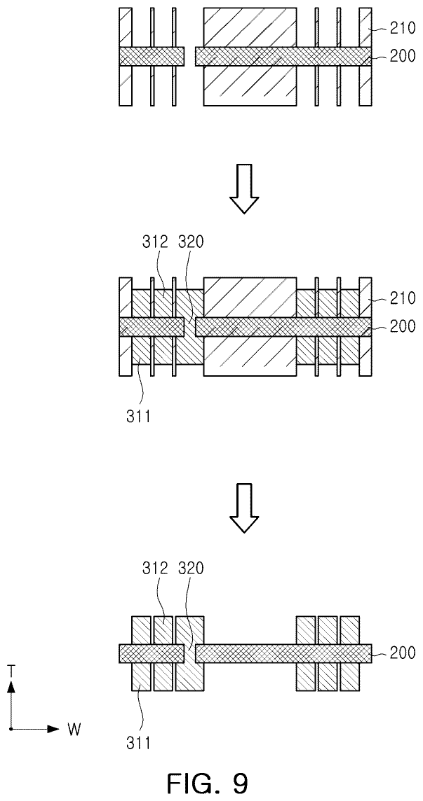

Thereafter, referring to FIG. 9, an opening having a planar coil shape may be formed in the partition wall 210. The opening may be formed using a known photolithography method, that is, a known exposure and development method, and the openings may be patterned in sequence or may be patterned at once. Exposure equipment or developer is not limited to any particular example, and may be appropriately selected and used depending on a photosensitive material to be used.

Thereafter, the first and second coils 311 and 312, the via 320, and the first and second lead-out portions 331 and 332 may be formed using the opening of the barrier wall 210 as a plating growth guide. In this case, when the elements are formed by a single plating process, the first and second coils 311 and 312, the vias 320, and the first and second lead-outs 331 and 332 may be integrally formed.

In the embodiments, since the metal substrate 200 is used, when forming the coil portion 300 by plating, whether to use the seed layer may be selective. That is, differently from the example in which a general CCL substrate or an insulating substrate is used, the coil portion 300 may be plated without a seed layer.

Accordingly, the possibility of defects in aligning the seed layer or a different in heights in copper (Cu) plating due to the defects may be reduced.

Meanwhile, in the method of manufacturing the coil portion 300 using the barrier wall 210 as in the embodiments, an opening pattern may be first formed in an insulator and plating may be performed using the opening as a guide, such that the shape of the coil conductor may be easily adjusted differently from an anisotropic plating technique. That is, side surfaces of the first and second coils 311 and 312 to be formed, which may be in contact with the partition wall 210 may be flat. Here, the configuration in which the surfaces are flat may include the configuration of being completely flat and also the configuration of being substantially flat. That is, it is considered that the wall surface of the opening pattern may have predetermined roughness by a photolithography method. The plating method is not limited to any particular example, and electrolytic plating and electroless plating may be used, but an example embodiment thereof is not limited thereto.

Thereafter, after forming the first and second coils 311 and 312, the via 320, and the first and second lead-out portions 331 and 332, the barrier wall 210 may be removed. The barrier wall 210 may be removed using a known stripper.

Thereafter, referring to FIG. 10, only the plated coil portion 300 may remain, and the metal substrate 200 may be removed. In the removing the metal substrate 200, a wet etching process may be used instead of a physical or mechanical method such as a laser. As an etchant, a known material which may selectively etch only the metal substrate 200 depending on the material of the metal substrate 200 may be used. For example, when the metal substrate 200 includes iron (Fe), nickel (Ni), and the like, sulfuric acid (H₂SO₄) may be used as the etchant, but an example embodiment thereof is not limited thereto.

By completely removing the metal substrate 200 through the etching process as above, the effective volume in the coil components 1000, 2000, 3000, and 4000 may increase.

Also, the process of forming the through-hole 110h using a CO₂ laser or the process of trimming the substrate in the region on the external side of the coil portion 300 may be unnecessary, such that defects occurring between processes may be reduced and the read time may be reduced such that efficiency may be increased.

Thereafter, the insulating film 600 may be formed to cover the coil portion 300 integrally. The insulating film 600 may be coated by chemical vapor deposition (CVD). The insulating film 600 may extend to a region between the first and second coils 311 and 312 from which the metal substrate 200 is removed, and may be disposed to cover the side surface of the via 320.

Finally, the insulating film 600 may be integrally formed in the region between the first and second coils 311 and 312 by pressing and curing the coil portion 300 on which the insulating film 600 is formed in the thickness direction (T direction). A boundary surface or a gap may be formed in the insulating film 600 according to conditions such as strength and temperature of compression, and the insulating film 600 may be completely integrated, but an example embodiment thereof is not limited thereto.

Here, strength of the compression may be preferably the strength in which the via 320 may not be damaged, and the compression may be more smoothly performed in a region not in contact with the via 320 among the first and second coils 311 and 312.

Through the compression process, the volume of the magnetic material in the upper and lower portions of the coil portion 300 may increase, such that the magnetic flux flow may become smoother, and inductance properties may improve.

After the body 100 is formed by laminating a magnetic sheet on and below the coil portion 300 on which the insulating film 600 is formed, the first and second external electrodes 400 and 500 may be disposed on the surface of the body 100 to be connected to the coil portion 300 and to be spaced apart from each other.

According to the aforementioned example embodiments, by completely removing the substrate supporting the coil portion from the thin film type inductor, the effective volume may increase by the volume occupied by the substrate, thereby improving inductance properties.

Also, a defect occurring during a mechanical processing process for the substrate in the coil component may be reduced.

While the embodiments have been illustrated and described above, it will be apparent to those skilled in the art that modifications and variations could be made without departing from the scope of the present disclosure as defined by the appended claims.

What is claimed is:

1. A coil component, comprising:
a body including a first surface and a second surface opposing each other in a first direction;
a coil portion disposed in the body and including first and second coils, and a via connecting the first and second coils to each other;
an insulating film covering the coil portion and extending to a region between the first and second coils; and
first and second external electrodes disposed on the body and connected to the coil portion,
wherein the insulating film is in contact with at least one of opposing surfaces of the first and second coils which face each other and is in contact with a side surface of the via.

2. The coil component of claim 1, wherein surface roughness of the at least one of the opposing surfaces of the first and second coils is different from surface roughness of a side surface of the first or second coil.

3. The coil component of claim 2, wherein the surface roughness of the at least one of the opposing surfaces of the first and second coils is greater than the surface roughness of the side surface of the first or second coil.

4. The coil component of claim 1, wherein surface roughness of the side surface of the via is different from surface roughness of a side surface of the first or second coil.

5. The coil component of claim 4, wherein surface roughness of the side surface of the via is greater than the surface roughness of the side surface of the first or second coil.

6. The coil component of claim 1, wherein surface roughness of the at least one of the opposing surfaces of the first and second coils is substantially the same as surface roughness of the side surface of the via.

7. The coil component of claim 1, wherein a spacing between the first and second coils in the region between the first and second coils in which the insulating film is disposed is smaller than a spacing between the first and second coils in a region in contact with the via.

8. The coil component of claim 1, wherein the insulating film disposed between the first and second coils has a boundary surface substantially parallel to the first direction.

9. The coil component of claim 8, wherein a spacing between the first coil and the boundary surface is substantially the same as a spacing between the second coil and the boundary surface.

10. The coil component of claim 1, wherein the insulating film disposed between the first and second coils is free of a boundary surface or a gap.

11. The coil component of claim 1,
wherein each of the first and second coils includes a plurality of turns, and
wherein a spacing between the first and second coils is constant at each turn.

12. The coil component of claim 1, wherein the insulating film extends along an outer surface of the coil portion, a shape of an outer surface of the insulating film corresponding to a shape of the outer surface of the coil portion, and
the insulating film covering the first coil and the insulating film covering the second coil is spaced apart form each other in the region between the first and second coils.

13. The coil component of claim 12, wherein a magnetic material included in the body is disposed in a spacing between the insulating film covering the first coil and the insulating film covering the second coil.

14. The coil component of claim 1,
wherein a spacing between the first and second coils in the region between the first and second coils in which the insulating film is disposed is greater than a sum of a thickness of the insulating film covering the first coil and a thickness of the insulating film covering the second coil, and
wherein the insulating film disposed between the first and second coils is free of a boundary surface or a gap.

15. The coil component of claim 1,
wherein the coil further includes a first lead-out portion extending from the first coil to the first surface of the body and connected to the first external electrode, and a second lead-out portion extending from the second coil to the second surface of the body and connected to the second external electrode, and
wherein, in the first and second lead-out portions, surfaces other than a portion in contact with the first and second coils and a portion in contact with the first and second external electrodes are covered by the insulating film.

16. A coil component, comprising:
a body including a first surface and a second surface opposing each other in a first direction;
a coil portion disposed in the body and including first and second coils, and a via connecting the first and second coils to each other;
a first insulating film covering an upper surface, a lower surface and a side surface of the first coil;
a second insulating film covering an upper surface, a lower surface and a side surface of the second coil; and
first and second external electrodes disposed on the body and connected to the first and second coils, respectively,
wherein each of the first and second insulating films extends along a side surface of the via.

17. The coil component of claim 16,
wherein the first insulating film covering the upper surface of the first coil is integrally formed with the second insulating film covering the lower surface of the second coil.

18. The coil component of claim 16,
wherein a boundary surface or a gap is included between the first insulating film covering the upper surface of the first coil and the second insulating film covering the lower surface of the second coil.

19. The coil component of claim 16,
an insulating resin and/or a magnetic material included in the body is disposed in a space between the first insulating film covering the upper surface of the first coil and the second insulating film covering the lower surface of the second coil.

20. The coil component of claim 16,
wherein an overall thickness of a portion of the coil portion including the via is greater than an overall thickness of another portion of the coil portion not including the via.
